(19) United States
(12) Patent Application Publication
(10) Pub. No.: US 2023/0035546 A1
(43) Pub. Date: Feb. 2, 2023

(54) POLY(LACTIC ACID) BLENDS HAVING IMPROVED CRYSTALLIZATION

(71) Applicant: Meridian, Inc., Bainbridge, GA (US)

(72) Inventors: Michael Mang, Bainbridge, GA (US); Phillip Van Trump, Decatur, GA (US)

(73) Assignee: Meridian, Inc., Bainbridge, GA (US)

(21) Appl. No.: 17/876,752

(22) Filed: Jul. 29, 2022

Related U.S. Application Data
(60) Provisional application No. 63/226,815, filed on Jul. 29, 2021.

(51) Int. Cl. C08L 67/04

(52) U.S. Cl. CPC C08L 67/04; C08L 2205/025; C08L 2205/03; C08L 2203/30

(57) ABSTRACT

A polymer composition is disclosed which includes poly(lactic acid), poly(3-hydroxypropionate), and optionally other biopolymers. This polymeric composition exhibits significant improvements in crystallization rate, as compared to poly(lactic acid) which has not been melt blended with poly(3-hydroxypropionate). Molded articles, particularly injection molded articles, which are formed from the aforementioned polymer composition are also disclosed.

### CROSS-REFERENCE TO RELATED APPLICATIONS

This application claims the benefit of the earlier filing date of provisional application 63/226,815, filed Jul. 29, 2021, the disclosure of which is incorporated by reference int its entirety.

### FIELD

This disclosure relates to biodegradable polymeric compositions. More particularly, this disclosure relates to biodegradable polymeric compositions comprising a mixture of poly(3-hydroxypropionate) and poly(lactic acid).

### BACKGROUND

Poly(lactic acid) (PLA) is an industrially compostable biopolymer that is used to produce films, fibers, and molded articles. Poly(lactic acid) has a stereochemical center in each monomeric repeat unit in the polymer backbone.

One difficulty in forming articles with poly(lactic acid) is that it has a relatively slow crystallization time, particularly when the monomeric repeat units are made up of a racemic mixture of lactic acid stereoisomers. These slower crystallization rates lead directly to slower cycle times in various polymer conversion processes, particularly in injection molding.

Therefore, it is desirable to provide a poly(lactic acid) composition having an improved crystallization rate

### SUMMARY OF THE INVENTION

In response to this need, the present disclosure, in a first aspect, provides a polymer composition. The polymer composition is made up of a melt blend of poly(3-hydroxypropionate) and poly(lactic acid).

In certain embodiments, the composition includes from about 0.1 to about 25 weight percent poly(3-hydroxypropionate). More preferably, the composition includes from about 0.5 to about 10 weight percent poly(3-hydroxypropionate).

According to some embodiments, the poly(3-hydroxypropionate) in the composition has a weight average molecular weight of greater than 10,000, as determined using ASTM D5296. More preferably, the poly(3-hydroxypropionate) in the composition has a weight average molecular weight from about 100,000 to about 250,000, as determined using ASTM D5296.

In some instances, the poly(lactic acid) in the composition has a weight average molecular weight of greater than 20,000, as determined using ASTM D5296. More preferably, the poly(lactic acid) in the composition has a weight average molecular weight from about 100,000 to about 275,000, as determined using ASTM D5296.

In general, the poly(lactic acid) may be made up of either repeat units of R-lactic acid, or repeat units of S-lactic acid, or a mixture thereof. In some embodiments, the poly(lactic acid) in the composition made up of at least 80 mole percent repeat units of R-lactic acid. More preferably, the poly(lactic acid) in the composition is made up of at least 95 mole percent repeat units of R-lactic acid. In other embodiments, the poly(lactic acid) in the composition is made up of at least 80 mole percent repeat units of S-lactic acid. More preferably, the poly(lactic acid) in the composition is made up of at least 95 mole percent repeat units of S-lactic acid.

In certain embodiments, the composition may also include at least one additional biopolymer selected from the group consisting of poly(hydroxyalkanoate), poly(caprolactone), poly(butylene succinate), poly(butylene succinate-co-butylene adipate), poly(butylene adipate-co-terephthalate), and mixtures thereof. Preferably, the composition includes from about 5 to about 35 weight percent of the least one additional biopolymer.

In some embodiments, the composition may also include a filler. The filler may be selected from the group consisting of calcium carbonate, talc, nano clays, nanocellulose, hemp fibers, kaolin, carbon black, wollastonite, glass fibers, carbon fibers, graphite fibers , mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, casein, collagen, gelatin, polysaccharides, guar gum, xanthan gum, succinoglycan, natural rubbers; rosinic acid, lignins, natural fibers, jute, kenaf, hemp, ground nut shells, wood flour, and mixtures thereof.

According to certain embodiments, the composition may also include at least one additive selected from the group consisting of colorants, lubricants, antioxidants, stabilizers, moisture scavengers, plasticizers, and flame retardants.

Advantageously, the polymer composition according to the present disclose exhibits significant improvements in crystallization rate, as compared to poly(lactic acid) which has not been melt blended with poly(3-hydroxypropionate). Preferably, the composition has a crystallization rate, as determined by ASTM E2070, which is at least 10 percent faster than a crystallization rate for the poly(lactic acid) by itself.

In a second aspect, the present disclosure provides an injection molded article which is formed from the aforementioned polymer composition.

### DETAILED DESCRIPTION

The present disclosure provides a poly(lactic acid) polymer composition. Advantageously, this poly(lactic acid) composition exhibits a faster crystallization rate as compared to conventional poly(lactic acid) compositions.

The composition of the present disclosure includes at least two polymers: poly(3-hydroxypropionate) and poly(lactic acid).

First, the composition includes poly(lactic acid). In general, the composition includes from about 50 to about 99 weight percent of poly(lactic acid). More preferably, the composition includes from about 80 to about 99 weight percent of poly(lactic acid).

In general, the poly(lactic acid) may be made up of either repeat units of R-lactic acid, or repeat units of S-lactic acid, or a mixture thereof. In some embodiments, the poly(lactic acid) in the composition made up of at least 80 mole percent repeat units of R-lactic acid. More preferably, the poly(lactic acid) in the composition is made up of at least 95 mole percent repeat units of R-lactic acid.

In other embodiments, however, the poly(lactic acid) in the composition is made up of at least 80 mole percent repeat units of S-lactic acid. More preferably, the poly(lactic acid) in the composition is made up of at least 95 mole percent repeat units of S-lactic acid.

Typically, the poly(lactic acid) in the polymer composition has a weight average molecular weight of greater than 20,000, as determined using ASTM D5296. More preferably, the poly(lactic acid) in the composition has a weight average molecular weight from about 100,000 to about 275,000, as determined using ASTM D5296.

Second, the composition also includes poly(3-hydroxypropionate). Typically, the composition includes from about 0.1 to about 25 weight percent poly(3-hydroxypropionate). More preferably, the composition includes from about 0.5 to about 10 weight percent poly(3-hydroxypropionate).

In general, the poly(3-hydroxypropionate) in the composition has a weight average molecular weight of greater than 10,000, as determined using ASTM D5296. More preferably, the poly(3-hydroxypropionate) in the composition has a weight average molecular weight from about 100,000 to about 250,000, as determined using ASTM D5296.

In addition to the poly(lactic acid) and the poly(3-hydroxypropionate), the composition may in some instances at least one additional biopolymer selected from the group consisting of poly(hydroxyalkanoate), polycaprolactone, poly(butylene succinate), poly(butylene succinate-co-butylene adipate), poly(lactic acid), and mixtures thereof. The amount of the additional biopolymer(s) is preferably from about 5 to about 35 weight percent of the overall composition.

Optionally, the composition may also include a filler. This filler material may be suitably selected from the group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, casein, collagen, gelatin, polysaccharides, guar gum, xanthan gum, succinoglycan, natural rubbers; rosinic acid, lignins, natural fibers, jute, kenaf, hemp, ground nut shells, wood flour, and mixtures thereof.

In some instances, the polymer composition may also include still other additives. For instance, the composition may also include at least one additive selected from the group consisting of colorants, lubricants, antioxidants, stabilizers, moisture scavengers, plasticizers, and flame retardants.

The polymer composition according to the present disclosure is preferably prepared by melt blending of the poly(3-hydroxypropionate), the poly(lactic acid), and any other polymers or additives which may optionally be included in the composition. This melt blending can be accomplished using conventional melt blending techniques such as single screw extrusion, twin screw extrusion, or three roll mills.

Polymer compositions prepared according to the present disclosure have been have significantly faster crystallization rates, as compared to the poly(lactic acid) starting material in unblended/unmodified form (i.e., as compared to poly(lactic acid) which has not been melt blended with poly(3-hydroxypropionate)). In general, the composition has a crystallization rate, as determined by ASTM E2070, which is at least 10 percent faster than a crystallization rate for the poly(lactic acid) by itself. More preferably, the composition has a crystallization rate, as determined by ASTM E2070, which is at least 20 percent faster than a crystallization rate for the poly(lactic acid) by itself.

Without being bound by theory, it is believed that the poly(3-hydroxypropionate) which is melt blended with the poly(lactic acid) provides nucleation sites in the composition which lead to faster nucleation, and ultimately crystallization, of the poly(lactic acid).

At the same time, because the poly(3-hydroxypropionate) is itself biodegradable and/or compostable, the blended composition remains industrially composable, just as the unblended poly(lactic acid) starting material is industrially compostable, as determined by ASTM D6400 for industrial or home compostability.

In addition to the polymer composition itself, the present disclosure also provides molded articles which are formed from the aforementioned polymer composition. For instance, the polymer compositions of the present disclosure may be used to form single-use plastic articles such as bottle closures, cutlery, or containers, using injection molding.

In general, these molded articles may be formed by a method selected from the group consisting of injection molding, compression molding, thermoforming, cast and blown film formation, extrusion coating, extrusion blow molding, injection stretch blow molding, fiber extrusion and profile extrusion. Preferably, the articles are formed by injection molding.

When formed from the present polymer composition, these molded articles may be formed at a faster rate than articles formed from only poly(lactic acid), due to the faster crystallization rate of the present polymer composition, which in turn allows for faster cycling times for the injection molding apparatus.

The present disclosure is also further illustrated by the following embodiments:

Embodiment 1. A polymer composition comprising a melt blend of poly(3-hydroxypropionate) and poly(lactic acid).

Embodiment 2. The polymer composition of Embodiment 1, wherein the composition comprises from about 0.1 to about 25 weight percent poly(3-hydroxypropionate).

Embodiment 3. The polymer composition of Embodiment 1 or 2, wherein the composition comprises from about 0.5 to about 10 weight percent poly(3-hydroxypropionate).

Embodiment 4. The polymer composition of any of the preceding Embodiments, wherein the poly(3-hydroxypropionate) in the composition has a weight average molecular weight of greater than 10,000, as determined using ASTM D5296.

Embodiment 5. The polymer composition of any of the preceding Embodiments, wherein the poly(3-hydroxypropionate) in the composition has a weight average molecular weight from about 100,000 to about 250,000, as determined using ASTM D5296.

Embodiment 6. The polymer composition of any of the preceding Embodiments, wherein the poly(lactic acid) in the composition has a weight average molecular weight of greater than 20,000, as determined using ASTM D5296.

Embodiment 7. The polymer composition of any of the preceding Embodiments, wherein the poly(lactic acid) in the composition has a weight average molecular weight from about 100,000 to about 275,000, as determined using ASTM D5296.

Embodiment 8. The polymer composition of any of the preceding Embodiments, wherein the poly(lactic acid) in the composition comprises at least 80 mole percent repeat units of R-lactic acid.

Embodiment 9. The polymer composition of any of the preceding Embodiments, wherein the poly(lactic acid) in the composition comprises at least 95 mole percent repeat units of R-lactic acid.

Embodiment 10. The polymer composition of any of Embodiments 1-7, wherein the poly(lactic acid) in the composition comprises at least 80 mole percent repeat units of S-lactic acid.

Embodiment 11. The polymer composition of any of Embodiments 1-7, wherein the poly(lactic acid) in the composition comprises at least 95 mole percent repeat units of S-lactic acid.

Embodiment 12. The polymer composition of any of the preceding Embodiments, wherein the composition further comprises at least one additional biopolymer selected from the group consisting of poly(hydroxyalkanoate), polycaprolactone, poly(butylene succinate), poly(butylene succinate-co-butylene adipate), poly(butylene adipate-co-terphthalate), and mixtures thereof.

Embodiment 13. The polymer composition of Embodiment 12, wherein the composition comprises from about 5 to about 35 weight percent of the least one additional biopolymer.

Embodiment 14. The polymer composition of any of the preceding Embodiments, further comprising a filler selected from the group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, casein, collagen, gelatin, polysaccharides, guar gum, xanthan gum, succinoglycan, natural rubbers; rosinic acid, lignins, natural fibers, jute, kenaf, hemp, ground nut shells, wood flour, and mixtures thereof.

Embodiment 15. The polymer composition of any of the preceding Embodiments, further comprising at least one additive selected from the group consisting of colorants, lubricants, antioxidants, stabilizers, moisture scavengers, plasticizers, and flame retardants.

Embodiment 16. The polymer composition of any of the preceding Embodiments, wherein the composition has a crystallization rate, as determined by ASTM E2070, which is at least 10 percent faster than a crystallization rate for the poly(lactic acid) by itself

Embodiment 17. An injection molded article comprising the polymer composition of any of the preceding Embodiments.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A polymer composition comprising a melt blend of poly(3-hydroxypropionate) and poly(lactic acid).

2. The polymer composition of claim 1, wherein the composition comprises from about 0.1 to about 25 weight percent poly(3-hydroxypropionate).

3. The polymer composition of claim 1, wherein the composition comprises from about 0.5 to about 10 weight percent poly(3-hydroxypropionate).

4. The polymer composition of claim 1, wherein the poly(3-hydroxypropionate) in the composition has a weight average molecular weight of greater than 10,000, as determined using ASTM D5296.

5. The polymer composition of claim 1, wherein the poly(3-hydroxypropionate) in the composition has a weight average molecular weight from about 100,000 to about 250,000, as determined using ASTM D5296.

6. The polymer composition of claim 1, wherein the poly(lactic acid) in the composition has a weight average molecular weight of greater than 20,000, as determined using ASTM D5296.

7. The polymer composition of claim 1, wherein the poly(lactic acid) in the composition has a weight average molecular weight from about 100,000 to about 275,000, as determined using ASTM D5296.

8. The polymer composition of claim 1, wherein the poly(lactic acid) in the composition comprises at least 80 mole percent repeat units of R-lactic acid.

9. The polymer composition of claim 1, wherein the poly(lactic acid) in the composition comprises at least 95 mole percent repeat units of R-lactic acid.

10. The polymer composition of claim 1, wherein the poly(lactic acid) in the composition comprises at least 80 mole percent repeat units of S-lactic acid.

11. The polymer composition of claim 1, wherein the poly(lactic acid) in the composition comprises at least 95 mole percent repeat units of S-lactic acid.

12. The polymer composition of claim 1, wherein the composition further comprises at least one additional biopolymer selected from the group consisting of poly(hydroxyalkanoate), polycaprolactone, poly(butylene succinate), poly(butylene succinate-co-butylene adipate), poly(butylene adipate-co-terphthalate), and mixtures thereof.

13. The polymer composition of claim 12, wherein the composition comprises from about 5 to about 35 weight percent of the least one additional biopolymer.

14. The polymer composition of claim 1, further comprising a filler selected from the group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, modified starches, chitins and chitosans, alginates, gluten, zein, casein, collagen, gelatin, polysaccharides, guar gum, xanthan gum, succinoglycan, natural rubbers; rosinic acid, lignins, natural fibers, jute, kenaf, hemp, ground nut shells, wood flour, and mixtures thereof.

15. The polymer composition of claim 1, further comprising at least one additive selected from the group consisting of colorants, lubricants, antioxidants, stabilizers, moisture scavengers, plasticizers, and flame retardants.

16. The polymer composition of claim 1, wherein the composition has a crystallization rate, as determined by ASTM E2070, which is at least 10 percent faster than a crystallization rate for the poly(lactic acid) by itself.

17. An injection molded article comprising the polymer composition of claim 1.
